(19) United States
(12) Patent Application Publication
(10) Pub. No.: US 2008/0198595 A1
(43) Pub. Date: Aug. 21, 2008

(54) Electronic candle

(76) Inventor: Chi-Shih Lai, Taipei Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/707,964

(22) Filed: Feb. 20, 2007

(51) Int. Cl. F21V 33/00

(52) U.S. Cl. 362/234

(57) ABSTRACT

An electronic candle includes a power supply port, a first illuminating module, a second illuminating module, and a light dispersing element. The power supply port connects with an AC power supply. The first illuminating module connects with the power supply port to input AC therein, and includes a first illuminating element, which emits primary light via the driving of AC. The second illuminating module includes a voltage converter and a second illuminating element. The voltage converter couples with the power supply port to receive AC, and converts the AC into DC. The second illuminating element emits additional light via the driving of the DC. The light dispersing element is transparent, and the primary light emitted by the first illuminating element and the additional light emitted by the second illuminating element are firstly emitted into the light dispersing element, then are combined and dispersed together by the light dispersing element.

### BACKGROUND OF THE INVENTION

1. Field of the Invention

The present invention relates to an electronic candle, and more specifically to an electronic candle in which an illuminating element is driven via AC and DC synchronously.

2. Description of the Prior Art

With the development of techniques and manufacturing processes, illuminant devices used for electronic illumination and decoration has brought forth the fresh and unique concepts to lighting design. Considering safety and utility, the light emitted by candles has been replaced by many other kinds of electronic illuminant devices. However, many people still adore the special ambience that is created by candlelight. Electronic candles currently available in the market are driven by electricity and imitate the appearance and the light emitted by a candle.

Prior art electronic candles imitated candles using bulbs and were an improvement over candles. Today, electronic candles have developed that twinkle via the sequencing and control of illuminating elements, thus simulating the flickering of a candle. Please refer to FIG. 1, in which an isometric view of an electronic candle of prior art is shown. The electronic candle 10 includes an illuminating element 11, two batteries 13, and a body 15. The body 15 includes a transparent portion 151, a candle body 153, and a candleholder 155. The body 153 is an empty cylinder, and the upper end and the bottom end of the body 153 are connected with the transparent portion 151 and the candleholder 155 respectively. The hollow portion of the body 153 contains the batteries 13. The illuminating element 11 is set in the transparent portion 151. The electronic candle 10 further includes a plurality of controlling circuits, which are not shown in FIG. 1. The controlling circuits are coupled with the batteries 13, and driven via DC generated by the batteries 13. The controlling circuits control the illuminating element 11 to emit light.

However, generally speaking, the electronic candle should provide illumination and decoration for a long time. If the batteries are used as the power supply to maintain the electric power driving the illuminating element, it is inevitable that the batteries will have to be changed frequently. Moreover, the brightness generated by the DC is limited.

Hence, the inventors of the present invention believe that these shortcomings above are able to be improved upon and suggest the present invention which is of a reasonable design and is an effective improvement based on deep research and thought.

### SUMMARY OF THE INVENTION

An object of the present invention is to provide an electronic candle, a first illuminating element of which emits a primary light via the driving of an AC, and a second illuminating element of which emits an additional light via the driving of a DC converted by the AC. Hence, the efficiency of the electronic candle is steadier and more diverse.

To achieve the above-mentioned object, an electronic candle is disclosed. The electronic candle comprises a power supply port, a first illuminating module, a second illuminating module and a light dispersing element. The power supply port connects with an AC power supply. The first illuminating module connects with the power supply port to receive AC and comprises a first illuminating element, which emits primary light via the driving of the AC. The second illuminating module comprises a voltage converter and a second illuminating element. The voltage converter couples with the power supply port to receive AC, and then converts the AC into DC. The second illuminating element emits additional light via the driving of the DC. The light dispersing element is transparent, and the primary light emitted by the first illuminating element and the additional light emitted by the second illuminating element are firstly emitted into the light dispersing element, and are then combined and dispersed together by the light dispersing element.

According to an embodiment, the second illuminating module further comprises a driving unit which generates a sequencing and controlling signal to control the second illuminating element to flicker.

To further understand the features and technical contents of the present invention, please refer to the following detailed description and drawings related to the present invention. However, the drawings are only to be used as references and explanations, and not to limit the present invention.

### BRIEF DESCRIPTION OF THE DRAWINGS

FIG. 1 is an isometric view of an electronic candle of a prior art;

FIG. 2 is a system block diagram of an electronic candle of the present invention;

FIG. 3 is a system block diagram of an electronic candle of a first embodiment of the present invention;

FIG. 4 is a circuit diagram of FIG. 3;

FIG. 5 is a cutaway view of an electronic candle of second embodiment of the present invention;

FIG. 6 is a cutaway view of an electronic candle of a third embodiment of the present invention;

FIG. 7 is a isometric view of an electronic candle of a preferred embodiment of the present invention; and

FIG. 8 is a cutaway view of the preferred embodiment of FIG. 7.

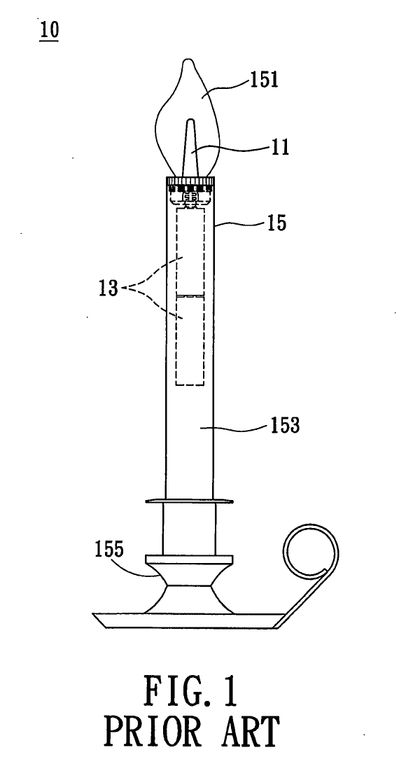

### DETAILED DESCRIPTION OF THE INVENTION

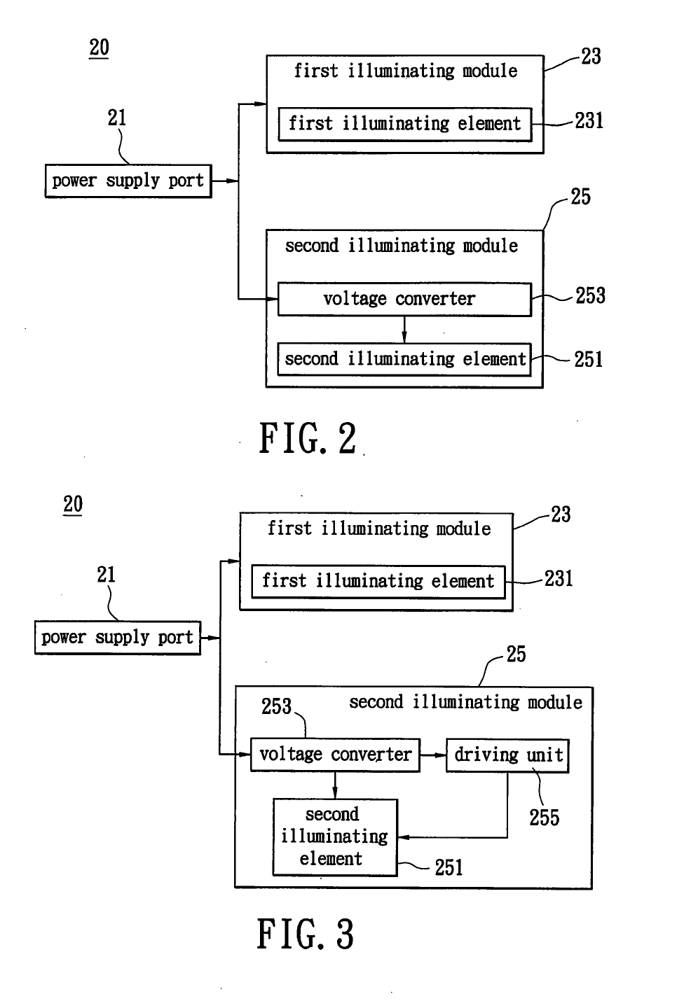

Please refer to FIG. 2, in which a system block diagram of an electronic candle of the present invention is shown. The electronic candle 20 includes a power supply port 21, a first illuminating module 23, and a second illuminating module 25. The power supply port 21 is connected with an AC (Alternating Current) power supply which receives AC from an external source, such as a power socket. The first illuminating module 23 is coupled with the power supply port 21 to input AC therein. The first illuminating module 23 includes a first illuminating element 231, which emits a primary light via the driving of AC. The second illuminating module 25 includes a voltage converter 253 and a second illuminating element 251. The voltage converter 253 is coupled with the power supply port 21 to receive AC, and then converts the AC into DC (Direct Current). The second illuminating element 251 emits an additional light via the driving of the DC. The light emitted by the second illuminating element 251 is an additional light.

The power supply port 21 is a power plug and connects with an AC power socket to receive AC. The voltage converter 253 includes an AC/DC voltage converting circuit to convert AC into DC.

The first illuminating element 231 includes at least one AC lamp and receives the AC driving primary light. The second illuminating element 251 includes at least one LED (Light Emitting Diode) or at least one DC lamp and receives the DC driving additional light.

The additional light combines the primary light to make the electronic candle 20 produce a special lighting effect. In this embodiment, the first illuminating element 231 and the second illuminating element 251 emit different tones of light. Hence, the primary light can be embellished by the different tones of the light. For example, if the tone of the primary light is yellow, the tone of the additional light can be red, orange, blue, and so on.

In another embodiment, the second illuminating element 251 is controlled to twinkle, the flicker of the additional light embellishes the primary light, and thereby the flickering of a candle can be created. Please refer FIG. 3, in which a system block diagram of an electronic candle a second embodiment of the present invention shown. The electronic candle 30 further includes a driving unit 255, which is coupled between the voltage converter 253 and the second illuminating element 251. The DC electric power outputted by the voltage converter 253 is inputted the second illuminating element 251 via the driving unit 255. The driving unit 255 generates sequencing and controlling signals, which is input to the second illuminating element 251, and the second illuminating element 251 flickers intermittently under the control of the sequencing and controlling signal. The second illuminating element 251 then emits the flickering additional light, and combines the flickering additional light with the primary light.

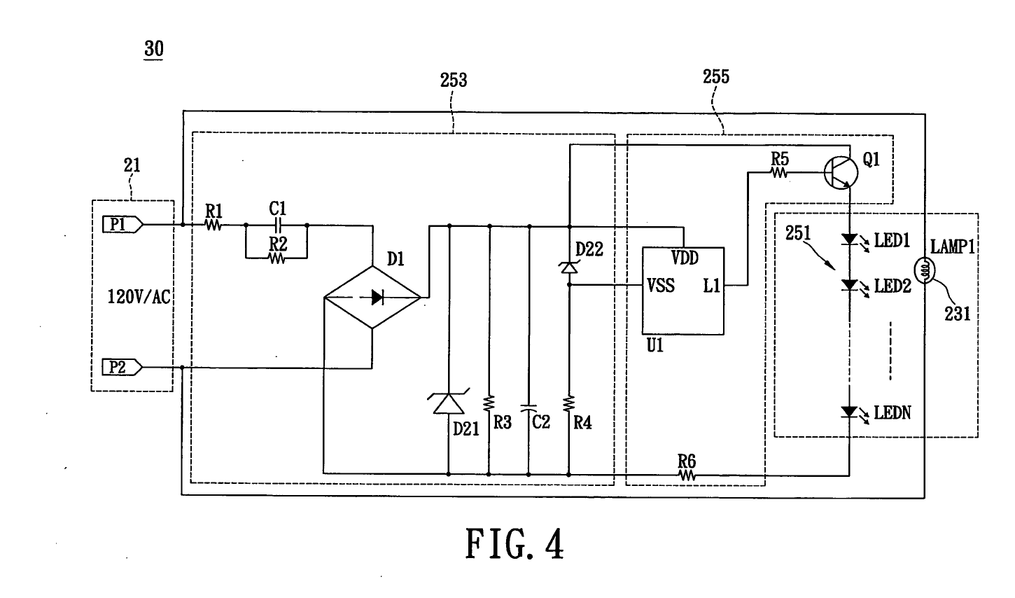

Please refer to FIG. 4, in which a circuit diagram of FIG. 3 of the electronic candle is shown. The first illuminating element 231 includes a lamp LAMP1. The second illuminating element 251 includes an N series-connection LEDs 1˜N, N is an integer and is greater than 1. The power supply port 21 includes two input ports P1, P2 and receives the input AC from the input ports P1, P2 to emit light.

The voltage converter 253 is an AC/DC voltage converting circuit and includes a bridge rectifier D1, two zener diodes D21, D22, four resistances R1, R2, R3, R4, and two capacitances C1, C2. The bridge rectifier D1, the resistances R1, R2, and the capacitances C1 are combined to form a front-end circuit which filters and rectifies the inputted AC and then generates DC. The zener diodes D21, D22, the resistances R3, R4, and the capacitances C2 are combined to form a back-end circuit to stabilize the DC generated by the front-end circuit. The driving unit 255 includes a sequencing controller U1, a transistor Q1, and two resistances R5, R6. The sequencing controller U1 generates sequencing and controlling signals. The power supply voltage of the sequencing controller U1 is DC which is generated by the voltage converter 253. The sequencing and controlling signal is outputted via the L1 pin. The transistor Q1 and the resistances R5, R6 cooperate to amplify the sequencing and controlling signals to drive the LED 1˜N to twinkle. FIG. 4 is only an embodiment of the electronic candle 30 and describes the present invention, and should not be used to limit the scope of the present invention.

The first illuminating element 231 in FIG. 4 is a lamp LAMP1, which is driven to emit light steadily by AC. In an after-mentioned embodiment, the first illuminating module 23 further includes a controlling unit (not shown) to control the first illuminating element 231 to twinkle. The controlling unit includes a sequencing controller and a relay. The sequencing controller generates sequencing and controlling signals. The sequencing and controlling signal controls the relaying of the power supply port 21 and the first illuminating element 231. Next, the relay drives the first illuminating element 231 to twinkle.

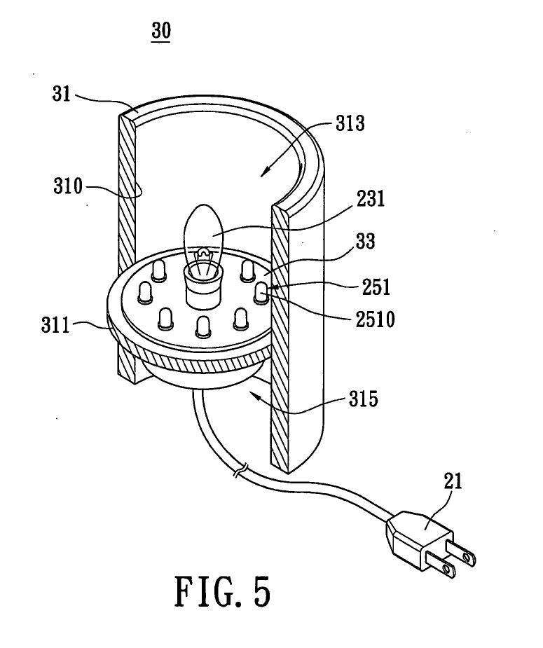

Please refer to FIG. 5, in which a cutaway view of an electronic candle of another embodiment of the present invention is shown. The electronic candle 30 includes a light dispersing element 31. The light dispersing element 31 is transparent. The primary light emitted by the first illuminating element 231 and the additional light emitted by the second illuminating element 251 are firstly emitted into the light dispersing element 31, then the primary light and the additional light are combined and dispersed together by the light dispersing element 31. Furthermore, the light dispersing element 31 has a hollow body, for receiving the first illuminating module 23 and the second illuminating module 25.

The light dispersing element 31 can be made of transparent materials such as plastic, PMMA (polymethyl methacrylate), glass, resin, or any kind of transparent textile, etc. The light dispersing element 31 can be fabricated by different processes according to different characteristics of the materials. Moreover, the light dispersing element 31 can be any tridimensional shapes, such as a cube, a sphere, a cylinder, a polygonal pole, etc. In FIG. 5, the light dispersing element 31 is an empty cylinder and imitates the shape of the candle. Furthermore, the surface of the light dispersing element 31 can be decorated with all kinds of decorative patterns. Thereby the appearance is attractive, and functionality is enhanced.

The light dispersing element 31 includes a first separating portion 311, which abuts against the inside wall 310 of the light dispersing element 31. The first separating portion 311 separates the light dispersing element 31 into a lighting area 313 and a controlling area 315. The first separating portion 311 further includes a lamp holder 33. The amp holder 33 set in the lighting area 313. The first illuminating element 231 and the second illuminating element 251 are disposed on the lamp holder 33. In FIG. 5, the first illuminating element 231 is a lamp, and the second illuminating element 251 includes a plurality of LEDs 2510. The first illuminating element 231 is set in the center of the lamp holder 33. The LEDs 2510 are disposed on the lamp holder 33 and surround the illuminating element 231. The controlling circuits, including the voltage converter 253 and the driving unit 255, are disposed on the controlling area 315. The first separating portion 311 defines a hole (not shown) through which the connecting wire between the lighting area 313 and the controlling area 315 can be disposed.

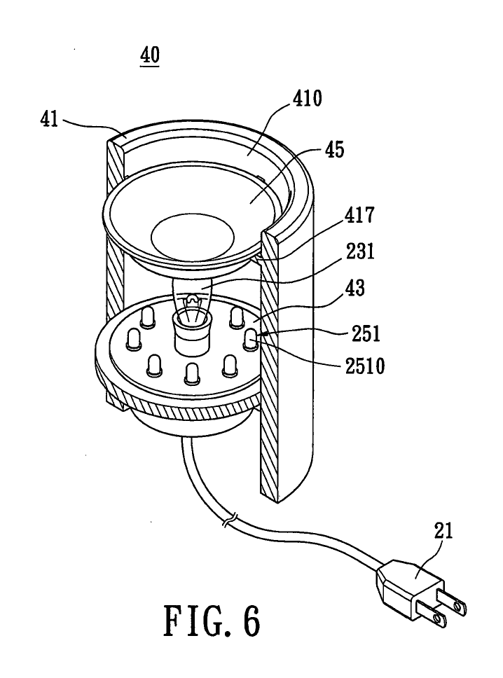

Please refer to FIG. 6, in which a cutaway view of an electronic candle of another embodiment of the present invention is shown. The electronic candle 40 further includes a containing groove 45, which corresponds to the light dispersing element 41 and is set in the electronic candle 40. In the present embodiment, the containing groove 45 is dish-shaped. The light dispersing element 41 further includes a second separating portion 417, which protrudes out of the inside wall 410 and corresponds to support the containing groove 45. The second separating portion 417 is ring-shaped and is joined with the inside wall 410 to support the containing groove 45. The containing groove 45 is set above the lamp holder 43, and also above the first illuminating element 231 and the second illuminating element 251, to absorb heat generated by the light of the first illuminating element 231 and the second illuminating element 251. Fragrant matter such as essential oils or dried flowers can be put in the containing groove 45. Hence, fragrances can be generated via heat caused by the light of the first illuminating element 231 and the second illuminating element 251.

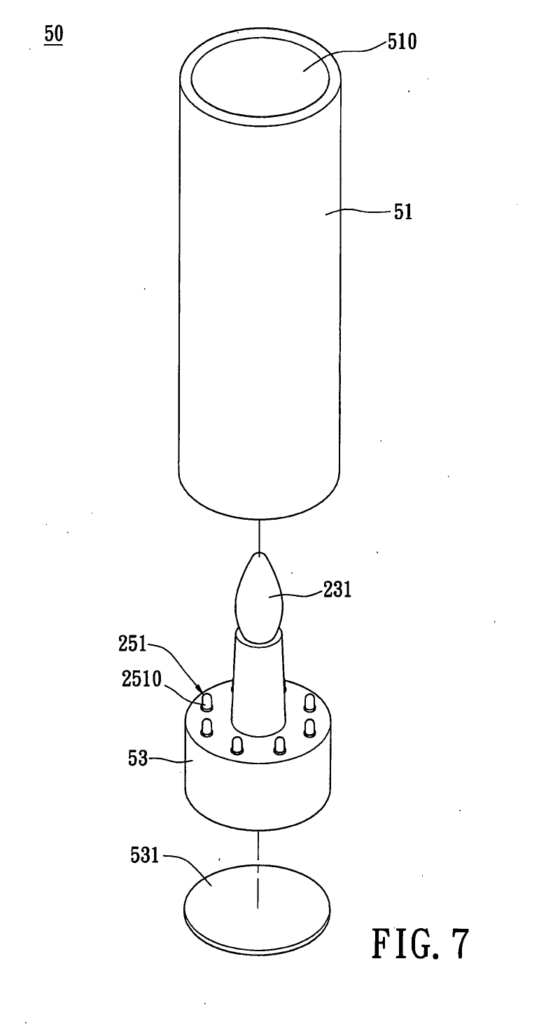

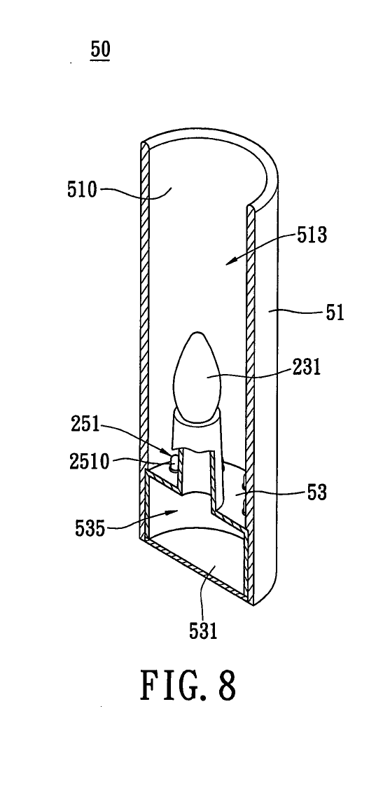

Please refer to FIGS. 7-8. FIG. 7 is an isometric view of an electronic candle of a preferred embodiment of the present invention. FIG. 8 is a cutaway view of the preferred embodiment shown in FIG. 7. The electronic candle 50 includes an empty column-shaped light dispersing element 51 and a lamp holder 53. The lamp holder 53 is a shell, and the first illuminating element 231 and the second illuminating element 251 are set outside the shell. The lamp holder 53 includes a bottom board 531. The structure of the lamp holder 53 corresponds to that of the light dispersing element 51 to fix and set the light dispersing element 51 therein. The lamp holder 53 is a cylinder, the outside wall of the lamp holder 53 abuts against the inside wall 510 of the light dispersing element 51 closely. Hence, a lighting area 513 is shaped above the space area of the light dispersing element 51. Furthermore, a controlling area 535 is defined inside the lamp holder 53, and the controlling circuits such as the voltage converter 253 and the driving unit 255 are set in the controlling area 535. The electronic candle 50 of the preferred embodiment is easy to manufacture, and replacing the first illuminating element 231 and the second illuminating element 251 is convenient.

In summary, the power supply of the electronic candle of the present invention is AC, the first illuminating element is driven to emit a primary light, and the second illuminating element is driven by converted DC to emit the additional light. Hence, the particular lighting effect of the electronic candle can be displayed. Compared to the battery powered light of the prior art, the lighting efficiency of the electronic candle of the present invention is steadier, and the design is more rich and colorful due to the combining of the additional light and the primary light.

What is disclosed above are only the preferred embodiments of the present invention, and therefore it is intended that the present invention not be limited to the particular embodiment disclosed. It should be understood by those skilled in the art that various equivalent changes may be made depending on the specification and the drawings of present invention without departing from the scope of the present invention.

1. An electronic candle, comprising:
a power supply port, connecting with an AC power supply;
a first illuminating module, coupling with the power supply port to receive AC, and comprising a first illuminating element, which emits a primary light via the driving of AC;
a second illuminating module, comprising:
a voltage converter, coupling with the power supply port to receive AC, and converting the AC into DC; and
a second illuminating element, emitting additional light via the driving of DC;
a light dispersing element, being transparent, wherein the primary light being emitted by the first illuminating element, and the additional light being emitted by the second illuminating element are firstly emitted into the light dispersing element, then the primary light and the additional light are combined together and dispersed by the light dispersing element; and
a dish contoured member being mounted in said light dispersing element above said first and second illuminating modules for absorbing heat generated by said first and second illuminating elements.

2. The electronic candle as claimed in claim 1, wherein the second illuminating module further comprises a driving unit coupled between the voltage converter and the second illuminating element, the driving unit generates a sequencing and controlling signal to control the second illuminating element to emit the sparkled additional light.

3. The electronic candle as claimed in claim 1, wherein the first illuminating module further comprises a controlling unit, which controls the first illuminating element to emit the sparkled additional light.

4. The electronic candle as claimed in claim 1, wherein the first illuminating element comprises at least one AC lamp, and the second illuminating element comprises at least one LED or at least one DC lamp.

5. The electronic candle as claimed in claim 1, further comprising a lamp holder, wherein the first illuminating element and the second illuminating element are set on the lamp holder.

6. The electronic candle as claimed in claim 5, wherein the second illuminating element comprises a plurality of LEDs or a plurality of DC lamps surrounding the first illuminating element, the first illuminating element comprising at least one AC lamp, and the first illuminating element and the second illuminating element are set on the lamp holder.

7. The electronic candle as claimed in claim 5, wherein the lamp holder is a shell, and the first illuminating element and the second illuminating element are set outside the shell, the voltage converter is set inside the shell, the light dispersing element has an empty body, and the structure of the lamp holder corresponding to that of the light dispersing element to set the light dispersing element therein.

8. The electronic candle as claimed in claim 5, wherein the light dispersing element has an empty body, and further comprises a first separating portion abutted against a inside wall of the light dispersing element, the first separating portion separates the space area of the light dispersing element into a lighting area and a controlling area, the lighting area the lamp holder are set inside the lighting area, and the controlling area is set with the voltage converter.

9. (canceled)

10. The electronic candle as claimed in claim 1, wherein the containing groove is dish-shaped, the light dispersing element has an empty body and comprising an inside wall and a second separating portion, the second separating portion protrudes out of the inside wall to support the containing groove.
